(19) United States
(12) Patent Application Publication
(10) Pub. No.: US 2022/0127779 A1
(43) Pub. Date: Apr. 28, 2022

(54) ANTIVIRAL ELEMENT AND PERSONNEL PROTECTION EQUIPMENT CONTAINING SAME

(71) Applicant: Nanotek Instruments Group, LLC, Dayton, OH (US)

(72) Inventors: Aruna Zhamu, Springboro, OH (US); Bor Z. Jang, Centerville, OH (US)

(21) Appl. No.: 17/081,418

(22) Filed: Oct. 27, 2020

(51) Int. Cl. D06M 11/74; D06M 16/00; B01D 39/20; A41D 31/30; A62B 18/02; A62B 17/00

(52) U.S. Cl. CPC D06M 11/74; D06M 16/00; B01D 39/2058; A41D 31/305; A62B 18/025; A62B 23/025; A62B 18/02; B01D 2239/0654; B01D 2239/0478; B01D 2239/10; B01D 2239/0442; A62B 17/006

(57) ABSTRACT

Provided is graphene-based personnel protection equipment (PPE) product, comprising: (a) a fabric, clothing, face shield, face mask, or glove body configured to support graphene sheets; and (b) graphene sheets deposited on a surface of the body or at least partially embedded in the body, wherein the graphene sheets comprise a plurality of discrete single-layer or few-layer graphene sheets selected from pristine graphene, graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof. Preferably, surfaces of graphene sheets carry an anti-microbial compound, preferably in the form of a nanoparticle, nano-wire, or nano-coating.

### FIELD

The present disclosure relates generally to the field of personnel protection equipment (PPE) and, particularly, to antiviral element for a PPE such as a filtration device, mask, glove, face shield, gown, and other clothing product and a PPE product containing this element, and a process for producing same.

### BACKGROUND

This disclosure is related to a personnel protection equipment (PPE) that is capable of protecting the user of this equipment against bacteria, viruses, other air-borne particles, or liquid-borne contaminants. The PPE includes, but not limited to, a filtration device, mask, glove, face shield, gown, a piece of textile/fabric, and other clothing product. This device may be an oral and/or nasal air filter that can remove and neutralize harmful virus from inhaled air contaminated with such virus, and from contaminated air exhaled from patients infected with such virus. In particular, the disclosure relates to such a device in the form of a face mask. The disclosure also relates to filter materials or members suitable for use in such a face mask and other filtration devices.

The inhalation of air contaminated by harmful virus and/or other micro-organisms is a common route for infection of human beings, particularly health workers and others caused to work with infected humans or animals. It is also known that air exhaled by infected patients is a source of contamination. At the present time the risk of infection by the so called “COVID-19” coronavirus is of particular concern. Masks incorporating a suitable filter material would be ideal for use as a barrier to prevent infection by this virus.

Air filters that are believed to be capable of removing such virus and/or other micro-organisms are known in the art. One type of such a filter comprises a fibrous or particulate substrate or layer and an antiviral or anti-bacteria compound deposited upon the surface and/or into the bulk of such a substrate or layer. This compound captures and/or neutralizes virus and/or other micro-organisms of concern. Examples of disclosures of such filters are summarized below:

For instance, U.S. Pat. No. 4,856,509 provides a face mask wherein select portions of the mask contain a viral destroying agent such as citric acid. U.S. Pat. No. 5,767,167 discloses aerogel foams suited for filtering media for capture of micro-organisms such as virus. U.S. Pat. No. 5,783,502 provides a fabric substrate with anti-viral molecules, particularly cationic groups such as quaternary ammonium cationic hydrocarbon groups bonded to the fabric. U.S. Pat. No. 5,851,395 is directed at a virus filter comprising a filter material onto which is deposited a virus-capturing material based on sialic acid (9-carbon monosaccharides having a carboxylic acid substituent on the ring). U.S. Pat. No. 6,182,659 discloses a virus-removing filter based on a Streptococcus agalactiae culture product. U.S. Pat. No. 6,190,437 discloses an air filter for removing virus from the air comprising a carrier substrate impregnated with iodine resins. U.S. Pat. No. 6,379,794 discloses filters based on glass and other high modulus fibers impregnated with an acrylic latex material. U.S. Pat. No. 6,551,608 discloses a porous thermoplastic material substrate and an antiviral substance made by sintering at least one antiviral agent with the thermoplastic substance. U.S. Pat. No. 7,029,516 discloses a filter system for removing particles from a fluid comprising a non-woven polypropylene base upon which is deposited an acidic polymer such as polyacrylic acid.

There is an ongoing and highly urgent need to improve such filters and other types of personnel protection equipment, particularly in view of concerns about the risks from “bird flu” and corona virus. The present inventors have identified filter materials and PPE elements which may be capable of increasing the level of removal of harmful virus and/or other micro-organisms from inhaled air and neutralization of these species, enabling the use of such materials in an improved nasal and/or mouth filter and other PPE products. The same filter materials may also be used as a filtration member in other filter devices, such as those for purification of water and air, separation of selected solvents, and recovery of spilled oil.

### SUMMARY

The present disclosure provides a graphene-based personnel protection equipment (PPE) product, comprising: (a) a fabric, clothing, face shield, face mask, or glove body configured to support graphene sheets; and (b) graphene sheets deposited on a surface of the fabric, clothing, face shield, or glove body or at least partially embedded in the body, wherein the graphene sheets comprise a plurality of discrete single-layer or few-layer graphene sheets selected from pristine graphene, graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

The PPE can include a filtration device (filtering out incoming pathogen), face mask, glove, face shield, gown, a piece of textile/fabric, and other clothing products.

In certain preferred embodiments, the graphene sheets are chemically bonded to a surface of the body optionally using an adhesive or binder. In certain situations, an adhesive or binder is not required, where graphene sheets (e.g. certain graphene oxide sheets) have natural chemically affinity to the material of the fabric, clothing, face shield, or glove body.

In certain embodiments, the fabric, clothing, face shield, face mask, or glove body comprises a woven or nonwoven structure of polymer fibers or glass fibers, or a polymer film. A wearable protective device can comprise a plastic film, rubber glove, face shield, or fabric or textile sheet. For face shield applications, the polymer film is preferably made of a transparent polymer.

In a PPE product, the fabric, clothing, face shield, or glove body may comprise a film or fibers of a polymer selected from cotton, cellulose, wool, polyolefin, polyester, polyamide, rayon, polyacrylonitrile, cellulose acetate, polystyrene, polyvinyl (e.g. polyvinyl chloride, PVC), poly (carboxylic acid), a rubber or elastomer, a biodegradable polymer, a water-soluble polymer, a copolymer thereof, and a combination thereof.

In certain preferred embodiments, the graphene sheets comprise a special class of graphene oxide or reduced graphene oxide having an oxygen content from 5% to 50% by weight based on the total graphene sheet weight.

Preferably, the fabric, clothing, face shield, face mask, or glove body further comprises an anti-microbial compound deposited thereon. The anti-microbial compound may be deposited on graphene sheet surfaces, an external surface of the body, or both.

In some embodiments, the product further comprises an anti-microbial compound distributed on surfaces of the graphene sheets and the graphene sheets have a specific surface area from 5 to 2,630 m²/g.

The anti-microbial compound may comprise an antiviral or anti-bacteria compound selected from acrylic acid, methacrylic acid, citric acid, an acidic polymer, a silver-organic idine antibacterial agent, an iodine resin, a sialic acid, a cationic group, a sulfonamide, a fluoroquinolone, or a combination thereof.

In certain embodiments, the anti-microbial compound comprises an antiviral or anti-bacteria compound selected from nano particles, nano-wires, or nano-coating of a material selected from Ti, V, Cr, Mn, Fe, Co, Ni, Cu, Zn, Zr, Mo, Pd, Ag, Cd, Au, Pt, W, Al, Sn, In, Pb, Bi, an alloy thereof, a mixture thereof, an oxide thereof, a sulfide thereof, a selenide thereof, a phosphide thereof, a boride thereof, or a combination thereof, wherein the nano particles, nanowires, or nano-coating have a diameter or thickness from 0.5 nm to 100 nm (preferably less than 20 nm and further preferably less than 10 nm, and most preferably less than 5 nm).

In certain preferred embodiments, the anti-microbial compound comprises silver nanowires, titanium dioxide nanoparticles, or a combination thereof.

The present disclosure also provides a process for producing a PPE product, the process comprising (a) preparing a fabric, clothing, face shield, face mask, or glove body having at least one external surface; and (b) depositing graphene sheets on the at least one external surface or at least partially embedding graphene sheets into the external surface. Multiple graphene sheets may be chemical bonded to a surface of the fabric, clothing, face shield, or glove body; however, graphene sheets still maintain some surfaces exposed to the open air or are accessible to the virus or bacteria. Graphene sheets may be partially embedded into the fabric, clothing, face shield, or glove body, but maintaining certain amounts of surfaces ready to come in contact with any biological agent. The graphene surfaces may be deposited with an anti-microbial compound.

In the process, step (b) may comprise a procedure of dispersing discrete graphene sheets, with or without an adhesive, in a gaseous medium to form a flowing fluid and impinging the flowing fluid upon the at least one external surface, allowing the graphene sheets to adhere to the at least one external surface.

In certain embodiments, step (b) comprises a procedure of dispersing discrete graphene sheets, with or without an adhesive, in a liquid medium to form a slurry, depositing the slurry onto the at least one external surface to form a wet graphene layer, and removing or drying the liquid medium from the wet graphene layer to form a layer of graphene sheets adhered to the external surface. Thermally curable or UV-curable adhesives may be used to bond graphene sheets to the PPE body.

The depositing procedure may comprise a procedure selected from casting, coating, spraying, printing, brushing, painting, dipping, or a combination thereof.

In certain embodiments, the process further comprises, before or after step (b), a step of depositing an anti-microbial compound onto surfaces of the graphene sheets.

In the disclosed PPE product, the supporting body may comprise a woven or nonwoven structure of polymer or glass fibers. The outer surfaces (to be exposed to pathogen) may preferably comprise polymer fibers selected from the group of cotton, cellulose, wool, polyolefins (e.g. polyethylene and polypropylene), polyester (e.g. PET), polyamide (e.g. nylon), rayon, polyacrylonitrile, cellulose acetate, polystyrene, polyvinyls, poly (carboxylic acid), a biodegradable polymer, a water-soluble polymer, copolymers thereof, and combinations thereof.

Preferably, the graphene sheets have an oxygen content from 5% to 50% by weight based on the total graphene sheet weight. The oxygen-containing functional groups appear to be capable of killing or de-activating certain microbial agents.

In the disclosed PPE product, the body or the supported graphene sheets, or both, may further comprise an anti-microbial compound. Preferably, the anti-microbial compound is distributed on surfaces of the graphene sheets and the graphene sheets have a specific surface area from 50 to 2,630 m²/g. With such a high specific surface area, the PPE body enables a dramatically higher surface of the anti-microbial compound that can directly attack the microbial pathogens (bacteria, virus, etc.)

The anti-microbial compound may comprise an antiviral or anti-bacteria compound selected from acrylic acid, methacrylic acid, citric acid, an acidic polymer, a silver-organic idine antibacterial agent, an iodine resin, a sialic acid (e.g. 9-carbon monosaccharides having a carboxylic acid substituent on the ring), a cationic group (e.g. quaternary ammonium cationic hydrocarbon group bonded to the fabric or graphene sheets), a sulfonamide, a fluoroquinolone, or a combination thereof.

The procedure of depositing graphene sheets on the surfaces of a fabric, clothing, face shield, or glove body preferably comprises a procedure selected from casting, coating (e.g. slot-die coating, comma coating, reverse-roll coating, etc.), spraying (e.g. air-assisted spraying, static charge-assisted spraying, ultrasonic spraying, etc.), printing (e.g. inkjet printing, screen printing, etc.), brushing, painting, or a combination thereof.

In certain embodiments, the process further comprises a step (c), before or after step (b), of depositing an anti-microbial compound or material onto surfaces of said graphene sheets. Step (c) preferably comprises a procedure selected from casting, coating, spraying, printing, brushing, painting, dipping, sputtering, physical vapor deposition, chemical vapor deposition, or a combination thereof.

The anti-microbial compound may comprise an antiviral or anti-bacteria nano particles, nano-wires, or nano-coating of a material selected from Ti, V, Cr, Mn, Fe, Co, Ni, Cu, Zn, Zr, Mo, Pd, Ag, Cd, Au, Pt, W, Al, Sn, In, Pb, Bi, an alloy thereof, a mixture thereof, an oxide thereof, a sulfide thereof, a selenide thereof, a phosphide thereof, a boride thereof, or a combination thereof, wherein the nano particles, nano-coating, or nanowires have a diameter or thickness from 0.5 nm to 100 nm.

The present disclosure further provides a graphene-based personnel protection equipment (PPE) product, comprising: (A) a fabric, clothing, face shield, face mask, or glove body (PPE body) configured to support graphene sheets; and (B) graphene sheets deposited on a surface of the PPE body or at least partially embedded in said body, wherein said graphene sheets comprise a plurality of discrete single-layer or few-layer graphene sheets selected from pristine graphene, graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof, and the graphene sheets are deposited with an anti-microbial compound selected from nano particles, nano-wires, or nano-coating of a material selected from Ti, V, Cr, Mn, Fe, Co, Ni, Cu, Zn, Zr, Mo, Pd, Ag, Cd, Au, Pt, W, Al, Sn, In, Pb, Bi, an alloy thereof, a mixture thereof, an oxide thereof, a sulfide thereof, a selenide thereof, a phosphide thereof, a boride thereof, or a combination thereof, wherein the nano particles, nanowires, or nano-coating has a diameter or thickness from 0.5 nm to 100 nm.

The present disclosure further provides a process for producing a PPE product, the process comprising (a) preparing a fabric, clothing, filter, face mask, face shield, or glove body having at least one external surface (e.g. facing the source of pathogen); (b) depositing graphene sheets on the at least one external surface or at least partially embedding graphene sheets into the external surface; and (c) a step, before or after step (b), of depositing an anti-microbial compound onto surfaces of the graphene sheets wherein the anti-microbial compound comprises nano particles, nano-wires, or nano-coating of a metallic material selected from Ti, V, Cr, Mn, Fe, Co, Ni, Cu, Zn, Zr, Mo, Pd, Ag, Cd, Au, Pt, W, Al, Sn, In, Pb, Bi, an alloy thereof, or a combination thereof and the metallic material is produced by bringing a metal precursor in direct contact with multiple sheets of graphene oxide, reduced graphene oxide, and/or functionalized graphene and converting (chemically or thermally) the precursor to the desired metal metal. The conversion procedure also acts to activate the surfaces of these nano particles, nano-wires, or nano-coating, imparting batter pathogen-killing capability.

The metal precursor may be selected from a metal nitrate, metal acetate, metal carbonate, metal citrate, metal sulfate, metal phosphate, or a combination thereof. These precursors can be readily converted into a metal deposited onto graphene sheet surfaces or surfaces of the PPE body.

In some preferred embodiments, step (c) comprises (i) mixing the metal precursor and graphene sheets in a liquid medium to form a suspension, (ii) removing the liquid medium to form dry graphene sheets coated with the metal precursor, and (iii) thermally converting the metal precursor to nano particles or nano-coating that is deposited on surfaces of graphene sheets. These procedures may be conducted preferably prior to graphene sheets being deposited on an exterior surface of a PPE body.

Also provide in this disclosure is a PPE product produced by the above-described process, the PPE product comprising graphene sheets deposited with nano particles, nano-wires, or nano-coating of a metallic material (an anti-microbial compound) selected from Ti, V, Cr, Mn, Fe, Co, Ni, Cu, Zn, Zr, Mo, Pd, Ag, Cd, Au, Pt, W, Al, Sn, In, Pb, Bi, an alloy thereof, or a combination thereof, wherein a graphene-to-metal weight ratio is from 1:99 to 99:1.

### BRIEF DESCRIPTION OF THE DRAWINGS

FIG. 1 A flow chart showing the most commonly used prior art process for producing graphene sheets.

FIG. 2(A) Schematic of a protective glove according to an embodiment of the present disclosure.

FIG. 2(B) Schematic of a protective clothing or fabric according to some embodiments of the present disclosure; left drawing shows a clothing without graphene sheets coated thereon and right drawing shows graphene sheets deposited on external surfaces of the protective clothing.

FIG. 2(C) Schematic of a face shield according to an embodiment of the present disclosure.

FIG. 2(D) Schematic of a face mask comprising a layer of graphene sheets deposited with nano particles, nano-wires, or nano-coating of an anti-viral metal, according to an embodiment of the present disclosure.

FIG. 2(E) Schematic of a facial mask comprising graphene sheets deposited with nano particles, nano-wires, or nano-coating of an anti-viral metal, implemented on an external surface of the facial mask body, according to an embodiment of the present disclosure.

### DESCRIPTION OF THE PREFERRED EMBODIMENTS

The present disclosure provides a graphene-based personnel protection equipment (PPE) product, comprising: (a) a fabric, clothing, face shield, face mask, or glove body configured to support graphene sheets; and (b) graphene sheets deposited on a surface of the fabric, clothing, face shield, face mask, or glove body or at least partially embedded in the body, wherein the graphene sheets comprise a plurality of discrete single-layer or few-layer graphene sheets selected from pristine graphene, graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

The graphene sheets may be chemically bonded to a surface of the body optionally using an adhesive or binder. In certain situations, an adhesive or binder is not required, where graphene sheets (e.g. certain graphene oxide sheets or functionalized graphene sheets) have natural chemically affinity to the material of the fabric, clothing, face shield, or glove body.

In certain embodiments, the fabric, clothing, face shield, face mask, or glove body comprises a woven or nonwoven structure of polymer fibers or glass fibers, or a polymer film. A wearable protective device can comprise a plastic film, rubber glove, face shield, or fabric or textile sheet.

In a PPE product, the fabric, clothing, face shield, face mask, or glove body may comprise a film (e.g. plastic film) or fibers of a polymer selected from cotton, cellulose, wool, polyolefin, polyester, polyamide, rayon, polyacrylonitrile, cellulose acetate, polystyrene, polyvinyl (e.g. polyvinyl chloride, PVC), poly (carboxylic acid), a rubber or elastomer, a biodegradable polymer, a water-soluble polymer, a copolymer thereof, and a combination thereof.

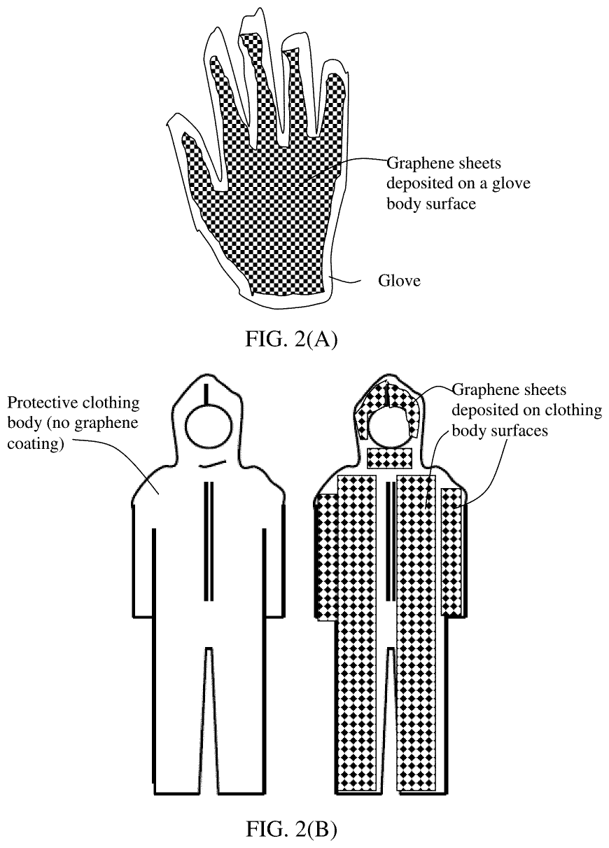

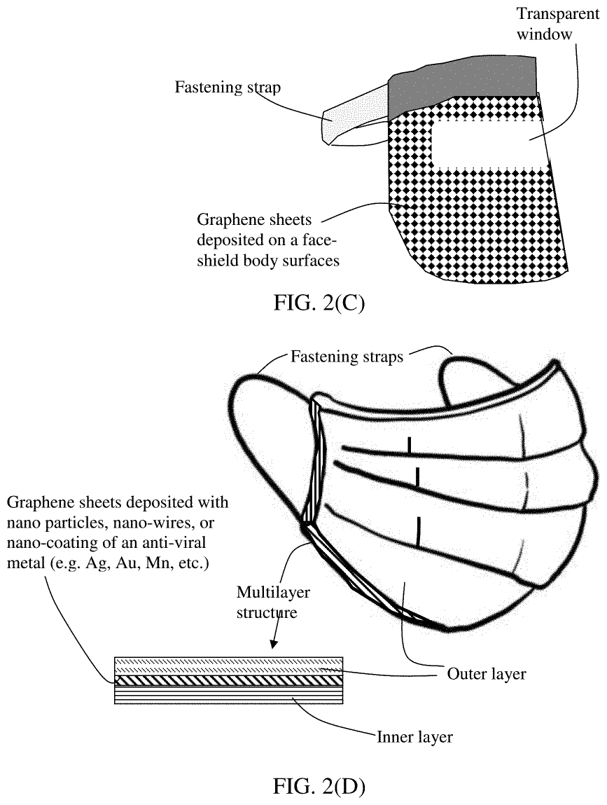

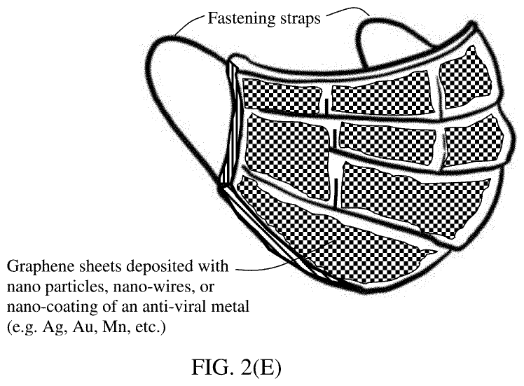

Illustrated in FIG. 2(A) is a protective glove (e.g. a surgical or examining glove used by a physician) that comprises a glove body configured to accommodate the hand fingers of a user. Graphene sheets are deposited on or bonded to the exterior surface of this glove. Graphene sheets, in combination with an anti-microbial compound, may be deposited to cover the substantially entire external surface or just portion of the external surface. An external surface refers to a surface where pathogens (virus or bacteria) may come in contact with.

FIG. 2(B) shows a schematic of a protective clothing (e.g. cap and/or gown) or fabric according to some embodiments of the present disclosure. The left drawing shows a clothing product without graphene sheets coated thereon and the right drawing shows graphene sheets deposited on external surfaces of the protective clothing. An anti-microbial compound may be coated on graphene sheet surfaces and/or fabric surfaces. Graphene sheets, in combination with an anti-microbial compound, may be deposited to cover the substantially entire external surface or just portion of the external surface.

FIG. 2(C) schematically shows a face shield according to an embodiment of the present disclosure. The face shield has a strap or other fastening means to help the user to properly wear such a facial shield. The face shield body has an external surface deposited with graphene sheets in selected locations, leaving behind a transparent portion (graphene-less window) allowing the wearer of such a shield to see through.

FIG. 2(D) schematically shows a face mask comprising a layer of graphene sheets deposited with nano particles, nano-wires, or nano-coating of an anti-viral metal, according to an embodiment of the present disclosure. In some embodiments, this layer of anti-viral metal-coated graphene sheets may be embedded as one of the multiple layers of the mask body or as coating layer disposed between the outer layer and the inner layer of a face mask body.

Shown in FIG. 2(E) schematically shows a facial mask comprising graphene sheets implemented on an external surface of the facial mask body. These graphene sheets are deposited with nano particles, nano-wires, or nano-coating of an anti-viral metal, according to an embodiment of the present disclosure.

The outer layer or the inner layer of a face mask typically comprises a air-permeable structure comprising a fibrous substrate or fabric, which can either be a woven or non-woven fabric. Examples of woven materials include those natural and synthetic fibers such as cotton, cellulose, wool, polyolefins (e.g. PE and PP), polyester (e.g. PET and PBT), polyamide (e.g. nylon), rayon, polyacrylonitrile, cellulose acetate, polystyrene, polyvinyls and any other synthetic polymers that can be processed into fibers. Examples of non-woven materials include polypropylene, polyethylene, polyester, nylon, PET and PLA. For the presently disclosed device, non-woven is preferred, which may be in the form of a non-woven sheet or pad.

Non-woven polyester is a preferred air-permeable structure because some of the desired anti-viral or anti-bacteria compounds, such as an acidic polymer, adhere better to polyester material. Also preferred is polypropylene non-woven fabric. The graphene sheets investigated herein appear to be compatible with all the polymeric fiber-based fabric structures. The grade of fibrous substrate or fabric which may be used to support graphene sheets may be determined by practice to achieve a suitable through-flow of air, and the density may be as known from the face-mask art to provide a mask of a comfortable weight.

Non-woven polypropylene of the type conventionally used for surgical masks and the like is widely available in sheet form. Suitable grades of non-woven polypropylene include the well-known grades commonly used for surgical face masks. Typical non-woven polypropylene materials found suitable for use in the face mask or other filtration devices have areal weights of 10-50 g/m² (gsm). Other suitable material weights can be determined empirically. Typical non-woven polyester suitable for use in the filtration devices has areal weights of 10-300 g/m². For face mask applications, polyester materials of weight 20-100 g/m² are preferred. Such materials are commercially available. Other suitable materials may be determined empirically without difficulty.

Alternatively, the porous layer substrate, other than non-woven or woven fabric, may be in other forms such as an open-cell foam, e.g. a polyurethane foam as is also used for air filters.

Face masks, including surgical masks and respirators, are commonly made with non-woven fabric, which has better bacteria filtration and air permeability while remaining less slippery than woven cloth. The material most commonly used to make them is polypropylene, but again can also be made of polystyrene, polycarbonate, polyethylene, or polyester, etc. The mask material of 20 g/m² or gsm is typically made in a spun-bond process, which involves extruding the melted plastic onto a conveyor. The material is extruded in a web, in which strands bond with each other as they cool. The 25 gsm fabric is typically made through the melt-blown process, wherein plastic is extruded through a die with hundreds of small nozzles and blown by hot air to become ultra-small fibers, cooling and binding on a conveyor. These fibers are typically less than a micron in diameter.

Surgical masks are composed of a multi-layered structure, generally by covering a layer of textile with non-woven bonded fabric on both sides. Non-woven materials are less expensive to make and cleaner due to their disposable nature. The structure incorporated as part of a mask body may be made with three or four layers. These disposable masks are often made with two filter layers effective in filtering out particles, such as bacteria above 1 micron. The filtration level of a mask depends on the fiber, the manufacturing process, the web structure, and the cross-sectional shape of the fiber. In the disclosed mask, the graphene layer can be incorporated as one of the multi-layers, but preferably not directly exposed to the outside air (not the outermost layer) and not directly in contact with the face of the wearer (not the inner-most layer). Masks may be made on a machine line that assembles the nonwovens from bobbins, ultrasonically welds the layers together, and stamps the masks with nose strips, ear loops, and other pieces. These procedures are well-known in the art.

Respirators also comprise multiple layers. The outer layer on both sides may be made of a protective nonwoven fabric between 20 and 100 g/m² density to create a barrier both against the outside environment and, on the inside, against the wearer's own exhalations. A pre-filtration layer follows which can be as dense as 250 g/m². This is usually a needled nonwoven which is produced through hot calendaring, in which plastic fibers are thermally bonded by running them through high pressure heated rolls. Graphene layer may be used to partially or totally replace this layer. In the case of partial substitution, graphene sheets may be deposited onto a primary surface of this needled nonwoven layer. This makes the pre-filtration layer thicker and stiffer to form the desired shape as the mask is used. The last layer may be a high efficiency melt-blown electret nonwoven material, which determines the filtration efficiency. This melt-blown layer, instead of or in addition to the pre-filtration layer, may be deposited with a graphene layer.

The graphene sheet surfaces may be deposited with an anti-viral or anti-bacterial compound. This deposition may be conducted before or after the graphene sheets form into a graphene layer. The anti-microbial compound may comprise an antiviral or anti-bacteria compound selected from acrylic acid, methacrylic acid, citric acid, an acidic polymer, a silver-organic idine antibacterial agent, an iodine resin, a sialic acid (e.g. 9-carbon monosaccharides having a carboxylic acid substituent on the ring), a cationic group (e.g. quaternary ammonium cationic hydrocarbon group bonded to the fabric or graphene sheets), a sulfonamide, a fluoroquinolone, or a combination thereof.

It is imperative that face masks and respirators produced are sterilized before being sent out of the factory.

The production of graphene is well-known in the art, but may be briefly described below:

Carbon materials can assume an essentially amorphous structure (glassy carbon), a highly organized crystal (graphite), or a whole range of intermediate structures that are characterized in that various proportions and sizes of graphite crystallites and defects are dispersed in an amorphous matrix. Typically, a graphite crystallite is composed of a number of graphene sheets or basal planes that are bonded together through van der Waals forces in the c-axis direction, the direction perpendicular to the basal plane. These graphite crystallites are typically micron- or nanometer-sized. The graphite crystallites are dispersed in or connected by crystal defects or an amorphous phase in a graphite particle, which can be a graphite flake, carbon/graphite fiber segment, carbon/graphite whisker, or carbon/graphite nano-fiber. In other words, graphene planes (hexagonal lattice structure of carbon atoms) constitute a significant portion of a graphite particle.

A single-layer graphene sheet is composed of carbon atoms occupying a two-dimensional hexagonal lattice. Multi-layer graphene is a platelet composed of more than one graphene plane. Individual single-layer graphene sheets and multi-layer graphene platelets are herein collectively called nano graphene platelets (NGPs) or graphene materials. NGPs include pristine graphene (essentially 99% of carbon atoms), slightly oxidized graphene (<5% by weight of oxygen), graphene oxide (≥5% by weight of oxygen), slightly fluorinated graphene (<5% by weight of fluorine), graphene fluoride ((≥5% by weight of fluorine), other halogenated graphene, and chemically functionalized graphene.

Our research group was among the first to discover graphene [B. Z. Jang and W. C. Huang, “Nano-scaled Graphene Plates,” U.S. patent application Ser. No. 10/274,473, submitted on Oct. 21, 2002; now U.S. Pat. No. 7,071,258 (Jul. 4, 2006)]. The processes for producing NGPs and NGP nanocomposites were recently reviewed by us [Bor Z. Jang and A Zhamu, “Processing of Nano Graphene Platelets (NGPs) and NGP Nanocomposites: A Review,” J. Materials Sci. 43 (2008) 5092-5101]. The production of various types of graphene sheets is well-known in the art.

For instance, the chemical processes for producing graphene sheets or platelets typically involve immersing powder of graphite or other graphitic material in a mixture of concentrated sulfuric acid, nitric acid, and an oxidizer, such as potassium permanganate or sodium perchlorate, forming a reacting mass that requires typically 5-120 hours to complete the chemical intercalation/oxidation reaction. Once the reaction is completed, the slurry is subjected to repeated steps of rinsing and washing with water. The purified product is commonly referred to as graphite intercalation compound (GIC) or graphite oxide (GO). The suspension containing GIC or GO in water may be subjected to ultrasonication to produce isolated/separated graphene oxide sheets dispersed in water. The resulting products are typically highly oxidized graphene (i.e. graphene oxide with a high oxygen content), which must be chemically or thermal reduced to obtain reduced graphene oxide (RGO).

Alternatively, the GIC suspension may be subjected to drying treatments to remove water. The dried powder is then subjected to a thermal shock treatment. This can be accomplished by placing GIC in a furnace pre-set at a temperature of typically 800-1100° C. (more typically 950-1050° C.) to produce exfoliated graphite (or graphite worms), which may be subjected to a high shear or ultrasonication treatment to produce isolated graphene sheets.

Alternatively, graphite worms may be re-compressed into a film form to obtain a flexible graphite sheet. Flexible graphite sheets are commercially available from many sources worldwide.

The starting graphitic material may be selected from natural graphite, synthetic graphite, highly oriented pyrolytic graphite, graphite fiber, graphitic nano-fiber, graphite fluoride, chemically modified graphite, meso-carbon micro-bead, partially crystalline graphite, or a combination thereof.

Pristine graphene sheets may be produced by the well-known liquid phase exfoliation or metal-catalyzed chemical vapor deposition (CVD).

Graphene films, flexible graphite sheets, and artificial graphite films are commonly regarded as three fundamentally different and patently distinct classes of materials.

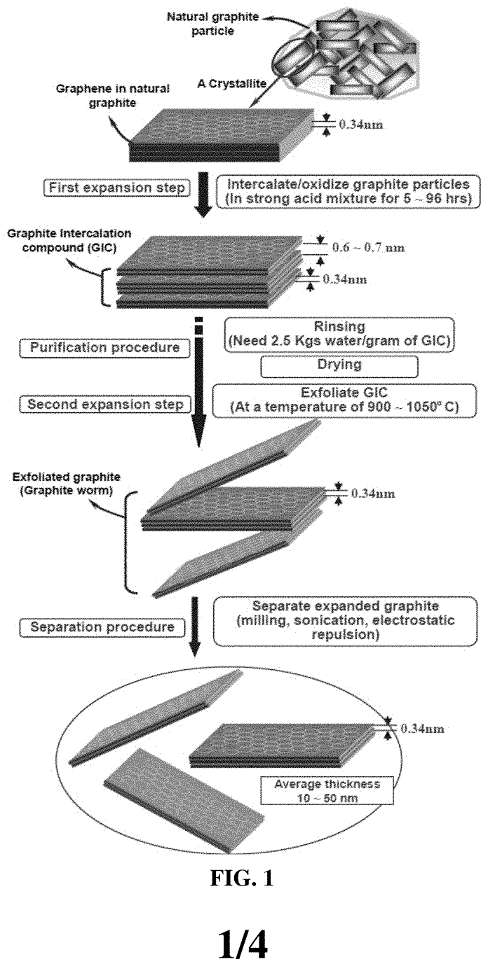

As schematically illustrated in the upper portion of FIG. 1, bulk natural graphite is a 3-D graphitic material with each graphite particle being composed of multiple grains (a grain being a graphite single crystal or crystallite) with grain boundaries (amorphous or defect zones) demarcating neighboring graphite single crystals. Each grain is composed of multiple graphene planes that are oriented parallel to one another. A graphene plane or hexagonal carbon atom plane in a graphite crystallite is composed of carbon atoms occupying a two-dimensional, hexagonal lattice. In a given grain or single crystal, the graphene planes are stacked and bonded via van der Waal forces in the crystallographic c-direction (perpendicular to the graphene plane or basal plane). The inter-graphene plane spacing in a natural graphite material is approximately 0.3354 nm.

Artificial graphite materials also contain constituent graphene planes, but they have an inter-graphene planar spacing, d₀₀₂, typically from 0.32 nm to 0.36 nm (more typically from 0.3339 to 0.3465 nm), as measured by X-ray diffraction. Many carbon or quasi-graphite materials also contain graphite crystals (also referred to as graphite crystallites, domains, or crystal grains) that are each composed of stacked graphene planes. These include meso-carbon mocro-beads (MCMBs), meso-phase carbon, soft carbon, hard carbon, coke (e.g. needle coke), carbon or graphite fibers (including vapor-grown carbon nano-fibers or graphite nano-fibers), and multi-walled carbon nanotubes (MW-CNT). The spacing between two graphene rings or walls in a MW-CNT is approximately 0.27 to 0.42 nm. The most common spacing values in MW-CNTs are in the range from 0.32-0.35 nm, which do not strongly depend on the synthesis method.

It may be noted that the “soft carbon” refers to a carbon material containing graphite domains wherein the orientation of the hexagonal carbon planes (or graphene planes) in one domain and the orientation in neighboring graphite domains are not too mis-matched from each other so that these domains can be readily merged together when heated to a temperature above 2,000° C. (more typically above 2,500° C.). Such a heat treatment is commonly referred to as graphitization. Thus, the soft carbon can be defined as a carbonaceous material that can be graphitized. In contrast, a “hard carbon” can be defined as a carbonaceous material that contain highly mis-oriented graphite domains that cannot be thermally merged together to obtain larger domains; i.e. the hard carbon cannot be graphitized.

The spacing between constituent graphene planes of a graphite crystallite in a natural graphite, artificial graphite, and other graphitic carbon materials in the above list can be expanded (i.e. the d₀₀₂ spacing being increased from the original range of 0.27-0.42 nm to the range of 0.42-2.0 nm) using several expansion treatment approaches, including oxidation, fluorination, chlorination, bromination, iodization, nitrogenation, intercalation, combined oxidation-intercalation, combined fluorination-intercalation, combined chlorination-intercalation, combined bromination-intercalation, combined iodization-intercalation, or combined nitrogenation-intercalation of the graphite or carbon material.

More specifically, due to the van der Waals forces holding the parallel graphene planes together being relatively weak, natural graphite can be treated so that the spacing between the graphene planes can be increased to provide a marked expansion in the c-axis direction. This results in a graphite material having an expanded spacing, but the laminar character of the hexagonal carbon layers is substantially retained. The inter-planar spacing (also referred to as inter-graphene spacing) of graphite crystallites can be increased (expanded) via several approaches, including oxidation, fluorination, and/or intercalation of graphite. The presence of an intercalant, oxygen-containing group, or fluorine-containing group serves to increase the spacing between two graphene planes in a graphite crystallite.

The inter-planar spaces between certain graphene planes may be significantly increased (actually, exfoliated) if the graphite/carbon material having expanded d spacing is exposed to a thermal shock (e.g. by rapidly placing this carbon material in a furnace pre-set at a temperature of typically 800-2,500° C.) without constraint (i.e. being allowed to freely increase volume). Under these conditions, the thermally exfoliated graphite/carbon material appears like worms, wherein each graphite worm is composed of many graphite flakes remaining interconnected. However, these graphite flakes have inter-flake pores typically in the pore size range of 20 nm to 10 μm.

Alternatively, the intercalated, oxidized, or fluorinated graphite/carbon material having expanded d spacing may be exposed to a moderate temperature (100-800° C.) under a constant-volume condition for a sufficient length of time. The conditions may be adjusted to obtain a product of limited exfoliation, having inter-flake pores of 2-20 nm in average size. This is herein referred to as a constrained expansion/exfoliation treatment. We have surprisingly observed that an Al cell having a cathode of graphite/carbon having inter-planar spaces 2-20 nm is capable of delivering a high energy density, high power density, and long cycle life.

In one process, graphite materials having an expanded inter-planar spacing are obtained by intercalating natural graphite particles with a strong acid and/or an oxidizing agent to obtain a graphite intercalation compound (GIC) or graphite oxide (GO). The presence of chemical species or functional groups in the interstitial spaces between graphene planes serves to increase the inter-graphene spacing, d₀₀₂, as determined by X-ray diffraction, thereby significantly reducing the van der Waals forces that otherwise hold graphene planes together along the c-axis direction. The GIC or GO is most often produced by immersing natural graphite powder in a mixture of sulfuric acid, nitric acid (an oxidizing agent), and another oxidizing agent (e.g. potassium permanganate or sodium perchlorate). The resulting GIC is actually some type of graphite oxide (GO) particles if an oxidizing agent is present during the intercalation procedure. This GIC or GO is then repeatedly washed and rinsed in water to remove excess acids, resulting in a graphite oxide suspension or dispersion, which contains discrete and visually discernible graphite oxide particles dispersed in water.

Water may be removed from the suspension to obtain “expandable graphite,” which is essentially a mass of dried GIC or dried graphite oxide particles. The inter-graphene spacing, d₀₀₂, in the dried GIC or graphite oxide particles is typically in the range from 0.42-2.0 nm, more typically in the range from 0.5-1.2 nm. It may be noted than the “expandable graphite” is not “expanded graphite”.

Upon exposure of expandable graphite to a temperature in the range from typically 800-2,500° C. (more typically 900-1,050° C.) for approximately 30 seconds to 2 minutes, the GIC undergoes a rapid volume expansion by a factor of 30-300 to form “exfoliated graphite” or “graphite worms”, Graphite worms are each a collection of exfoliated, but largely un-separated graphite flakes that remain interconnected. In exfoliated graphite, individual graphite flakes (each containing 1 to several hundred of graphene planes stacked together) are highly spaced from one another, having a spacing of typically 2.0 nm-10 μm. However, they remain physically interconnected, forming an accordion or worm-like structure.

In graphite industry, graphite worms can be re-compressed to obtain flexible graphite sheets or foils that typically have a thickness in the range from 0.1 mm (100 μm)-0.5 mm (500 μm). Such flexible graphite sheets may be used as a type of graphitic heat spreader element.

Alternatively, in graphite industry, one may choose to use a low-intensity air mill or shearing machine to simply break up the graphite worms for the purpose of producing the so-called “expanded graphite” flakes which contain mostly graphite flakes or platelets thicker than 100 nm (hence, not a nano material by definition). It is clear that the “expanded graphite” is not “expandable graphite” and is not “exfoliated graphite worm” either. Rather, the “expandable graphite” can be thermally exfoliated to obtain “graphite worms,” which, in turn, can be subjected to mechanical shearing to break up the otherwise interconnected graphite flakes to obtain “expanded graphite” flakes. Expanded graphite flakes typically have the same or similar inter-planar spacing (typically 0.335-0.36 nm) of their original graphite. Multiple expended graphite flakes may be roll-pressed together to form graphitic films, which are a variation of flexible graphite sheets.

Alternatively, the exfoliated graphite or graphite worms may be subjected to high-intensity mechanical shearing (e.g. using an ultrasonicator, high-shear mixer, high-intensity air jet mill, or high-energy ball mill) to form separated single-layer and multi-layer graphene sheets (collectively called NGPs), as disclosed in our U.S. application Ser. No. 10/858,814 (U.S. Pat. Pub. No. 2005/0271574) (now abandoned). Single-layer graphene can be as thin as 0.34 nm, while multi-layer graphene can have a thickness up to 100 nm, but more typically less than 3 nm (commonly referred to as few-layer graphene). Multiple graphene sheets or platelets may be made into a sheet of NGP paper using a paper-making process.

In GIC or graphite oxide, the inter-graphene plane separation has been increased from 0.3354 nm in natural graphite to 0.5-1.2 nm in highly oxidized graphite oxide, significantly weakening the van der Waals forces that hold neighboring planes together. Graphite oxide can have an oxygen content of 2%-50% by weight, more typically 20%-40% by weight. GIC or graphite oxide may be subjected to a special treatment herein referred to as “constrained thermal expansion”. If GIC or graphite oxide is exposed to a thermal shock in a furnace (e.g. at 800-1,050° C.) and allowed to freely expand, the final product is exfoliated graphite worms. However, if the mass of GIC or graphite oxide is subjected to a constrained condition (e.g. being confined in an autoclave under a constant volume condition or under a uniaxial compression in a mold) while being slowly heated from 150° C. to 800° C. (more typically up to 600°) for a sufficient length of time (typically 2 minutes to 15 minutes), the extent of expansion can be constrained and controlled, and the product can have inter-flake spaces from 2.0 nm to 20 nm, or more desirably from 2 nm to 10 nm.

It may be noted that the “expandable graphite” or graphite with expanded inter-planar spacing may also be obtained by forming graphite fluoride (GF), instead of GO. Interaction of F₂ with graphite in a fluorine gas at high temperature leads to covalent graphite fluorides, from (CF)ₙ to (C₂F)ₙ, while at low temperatures graphite intercalation compounds (GIC) CₓF (2≤x≤24) form. In (CF)ₙ carbon atoms are sp3-hybridized and thus the fluorocarbon layers are corrugated consisting of trans-linked cyclohexane chairs. In (C₂F)ₙ only half of the C atoms are fluorinated and every pair of the adjacent carbon sheets are linked together by covalent C—C bonds. Systematic studies on the fluorination reaction showed that the resulting F/C ratio is largely dependent on the fluorination temperature, the partial pressure of the fluorine in the fluorinating gas, and physical characteristics of the graphite precursor, including the degree of graphitization, particle size, and specific surface area. In addition to fluorine (F₂), other fluorinating agents (e.g. mixtures of F₂ with Br₂, Cl₂, or I₂) may be used, although most of the available literature involves fluorination with F₂ gas, sometimes in presence of fluorides.

We have observed that lightly fluorinated graphite, CₓF (2≤x≤24), obtained from electrochemical fluorination, typically has an inter-graphene spacing (d₀₀₂) less than 0.37 nm, more typically <0.35 nm. Only when x in CₓF is less than 2 (i.e. 0.5≤x<2) can one observe a d₀₀₂ spacing greater than 0.5 nm (in fluorinated graphite produced by a gaseous phase fluorination or chemical fluorination procedure). When x in CₓF is less than 1.33 (i.e. 0.5≤x<1.33) one can observe a d₀₀₂ spacing greater than 0.6 nm. This heavily fluorinated graphite is obtained by fluorination at a high temperature (>>200° C.) for a sufficiently long time, preferably under a pressure >1 atm, and more preferably >3 atm. For reasons remaining unclear, electrochemical fluorination of graphite leads to a product having a d spacing less than 0.4 nm even though the product CₓF has an x value from 1 to 2. It is possible that F atoms electrochemically introduced into graphite tend to reside in defects, such as grain boundaries, instead of between graphene planes and, consequently, do not act to expand the inter-graphene planar spacing.

The nitrogenation of graphite can be conducted by exposing a graphite oxide material to ammonia at high temperatures (200-400° C.). Nitrogenation may also be conducted at lower temperatures by a hydrothermal method; e.g. by sealing GO and ammonia in an autoclave and then increased the temperature to 150-250° C.

In addition to N, O, F, Br, Cl, or H, the presence of other chemical species (e.g. Na, Li, K, Ce, Ca, Fe, NH₄, etc.) between graphene planes can also serve to expand the inter-planar spacing, creating room to accommodate electrochemically active materials therein. The expanded interstitial spaces between graphene planes (hexagonal carbon planes or basal planes) are found by us in this study to be surprisingly capable of accommodating Al⁺³ ions and other anions (derived from electrolyte ingredients) as well, particularly when the spaces are from 2.0 nm to 20 nm. It may be noted that graphite can electrochemically intercalated with such chemical species as Na, Li, K, Ce, Ca, NH₄, or their combinations, which can then be chemically or electrochemically ion-exchanged with metal elements (Bi, Fe, Co, Mn, Ni, Cu, etc.). All these chemical species can serve to expand the inter-planar spacing. The spacing may be dramatically expanded (exfoliated) to have inter-flake pores that are 20 nm-10 μm in size.

Once the graphene sheets are produced, they can be made into a mask body according to several embodiments of the instant disclosure. One process for producing the herein disclosed filtration material or member comprises (a) preparing a layer of woven or nonwoven fabric having two primary surfaces; and (b) depositing a graphene layer on at least one of the two primary surfaces.

Step (b) may comprise a procedure of dispersing discrete graphene sheets, with or without an adhesive, in a gaseous medium to form a flowing fluid and impinging the flowing fluid upon at least one of the two primary surfaces, allowing said graphene sheets to adhere to said at least one primary surface.

Alternatively, step (b) can comprise a procedure of dispersing discrete graphene sheets, with or without an adhesive, in a liquid medium to form a slurry, depositing the slurry onto at least one of the two primary surfaces to form a wet graphene layer, and removing or drying the liquid medium from said wet graphene layer to form the graphene layer. Thermally curable or UV-curable adhesives are more desirable.

The procedure of depositing preferably comprises a procedure selected from casting, coating (e.g. slot-die coating, comma coating, reverse-roll coating, etc.), spraying (e.g. air-assisted spraying, static charge-assisted spraying, ultrasonic spraying, etc.), printing (e.g. inkjet printing, screen printing, etc.), brushing, painting, or a combination thereof.

The process is preferably a roll-to-roll or reel-to-reel process, wherein step (a) comprises (i) preparing a roll of woven or nonwoven fabric, (ii) continuously feeding a continuous length of a sheet of the fabric from the roll (mounted on a roller or reel) into a deposition zone, (iii) depositing a graphene layer onto at least one of the two primary surfaces to form a graphene layer-coated fabric, and (iv) collecting the graphene layer-coated fabric on a winding roller.

The process may further comprise a step of incorporating the filtration material (member) into a mask body, which is fitted with fastening means (e.g. elastic straps) to form the face mask.

The graphene layer-coated fabric can be made to contain microscopic pores (<2 nm), meso-scaled pores having a pore size from 2 nm to 50 nm, or larger pores (preferably 50 nm to 1 μm). Based on well-controlled pore size alone, the instant graphene layer-coated fabric can be an exceptional filter material for air or water filtration.

Further, the graphene surface chemistry can be independently controlled to impart different amounts and/or types of functional groups to graphene sheets (e.g. as reflected by the percentage of O, F, N, H, etc. in the sheets). In other words, the concurrent or independent control of both pore sizes and chemical functional groups at different sites of the internal structure provide unprecedented flexibility or highest degree of freedom in designing and making graphene-coated fabric that exhibits many unexpected properties, synergistic effects, and some unique combination of properties that are normally considered mutually exclusive (e.g. some part of the structure is hydrophobic and other part hydrophilic; or the filtration structure is both hydrophobic and oleophilic). A surface or a material is said to be hydrophobic if water is repelled from this material or surface and that a droplet of water placed on a hydrophobic surface or material will form a large contact angle. A surface or a material is said to be oleophilic if it has a strong affinity for oils and not for water. The present method allows for precise control over hydrophobicity, hydrophilicity, and oleophilicity.

The present disclosure also provides an oil-removing, oil-separating, or oil-recovering device, which contains the presently invented graphene layer-coated fabric as an oil-absorbing or oil-separating element. Also provided is a solvent-removing or solvent-separating device containing the graphene layer-coated fabric as a solvent-absorbing element.

A major advantage of using the instant graphene-coated fabric structure as an oil-absorbing element is its structural integrity. Due to the notion that graphene sheets may be chemically bonded by an adhesive, the resulting structure would not get disintegrated upon repeated oil absorption operations.

Another major advantage of the instant technology is the flexibility in designing and making oil-absorbing elements that are capable of absorbing oil up to a large amount yet still maintaining its structural shape (without significant expansion). This amount depends upon the specific pore volume of the filtration structure.

The disclosure also provides a method to separate/recover oil from an oil-water mixture (e.g. oil-spilled water or waste water from oil sand). The method comprises the steps of (a) providing an oil-absorbing element comprising a graphene layer-coated fabric; (b) contacting an oil-water mixture with the element, which absorbs the oil from the mixture; and (c) retreating the oil-absorbing element from the mixture and extracting the oil from the element. Preferably, the method comprises a further step of (d) reusing the element.

Additionally, the disclosure provides a method to separate an organic solvent from a solvent-water mixture or from a multiple-solvent mixture. The method comprises the steps of (a) providing an organic solvent-absorbing element comprising an integral graphene layer-coated fabric structure; (b) bringing the element in contact with an organic solvent-water mixture or a multiple-solvent mixture containing a first solvent and at least a second solvent; (c) allowing this element to absorb the organic solvent from the mixture or absorb the first solvent from the at least second solvent; and (d) retreating the element from the mixture and extracting the organic solvent or first solvent from the element. Preferably, the method contains an additional step (e) of reusing the solvent-absorbing element.

The following examples are used to illustrate some specific details about the best modes of practicing the instant disclosure and should not be construed as limiting the scope of the disclosure.

### Example 1: Preparation of Single-Layer Graphene Sheets and the Graphene Layer from Meso-Carbon Micro-Beads (MCMBs)

Meso-carbon microbeads (MCMBs) were supplied from China Steel Chemical Co., Kaohsiung, Taiwan. This material has a density of about 2.24 g/cm³ with a median particle size of about 16 μm. MCMB (10 grams) were intercalated with an acid solution (sulfuric acid, nitric acid, and potassium permanganate at a ratio of 4:1:0.05) for 48-96 hours. Upon completion of the reaction, the mixture was poured into deionized water and filtered. The intercalated MCMBs were repeatedly washed in a 5% solution of HCl to remove most of the sulfate ions. The sample was then washed repeatedly with deionized water until the pH of the filtrate was no less than 4.5. The slurry was then subjected ultrasonication for 10-100 minutes to produce GO suspensions. TEM and atomic force microscopic studies indicate that most of the GO sheets were single-layer graphene when the oxidation treatment exceeded 72 hours, and 2- or 3-layer graphene when the oxidation time was from 48 to 72 hours.

The GO sheets contain oxygen proportion of approximately 35%-47% by weight for oxidation treatment times of 48-96 hours. GO sheets were suspended in water. The GO suspension was cast into thin graphene oxide films on a glass surface and, separately, was also slot die-coated onto a PET film substrate, dried, and peeled off from the PET substrate to form GO films. The GO films were separately heated from room temperature to 1,500° C. and then slightly roll-pressed to obtain reduced graphene oxide (RGO) films (free-standing layers) for use as a porous graphene layer in a filtration device (e.g. between an outer non-woven fabric layer and an internal layer in a face mask).

On a separate basis, a metal precursor (e.g. silver acetate) was added to the GO-water suspension to form a multiple-component suspension or slurry. The slurry was cast into thin graphene oxide/Ag acetate films on a glass surface, dried, and peeled off from the glass substrate to form GO/metal precursor films. The films were heated from room temperature to 650° C. to convert the silver acetate to Ag nanoparticles and, concurrently thermally reduce GO to become RGO. The films were then slightly roll-pressed to obtain Ag nanoparticle-coated RGO films (free-standing layers) for use as an anti-virus layer (e.g. this layer can be disposed on the front surface of a face mask or between an outer non-woven fabric layer and an internal layer in a face mask).

Separately, an ultrasonic spraying procedure was conducted to spray the GO-water solution onto a primary surface of a sheet of PP-based non-woven fabric (e.g. for a face mask) or a transparent plastic film (e.g. PVC film for a protective gown or face shield). The GO sheets in this suspension can be pre-deposited with an anti-microbial compound (e.g. Ag nanowires, Au nanoparticles). Upon drying, we obtained graphene/Au or graphene/Ag layer-coated fabric structure. We observed that some of the GO sheets partially penetrated into the bulk of the PP non-woven structure. These GO sheets were held in place by the PP fibers even without using any adhesive resin.

### Example 2: Preparation of Pristine Graphene Sheets (0% Oxygen) and Graphene Layer

Pristine graphene sheets were produced by using the direct ultrasonication or liquid-phase production process. In a typical procedure, five grams of graphite flakes, ground to approximately 20 μm or less in sizes, were dispersed in 1,000 mL of deionized water (containing 0.1% by weight of a dispersing agent, Zonyl® FSO from DuPont) to obtain a suspension. An ultrasonic energy level of 85 W (Branson 5450 Ultrasonicator) was used for exfoliation, separation, and size reduction of graphene sheets for a period of 15 minutes to 2 hours. The resulting graphene sheets are pristine graphene that have never been oxidized and are oxygen-free and relatively defect-free. There are no other non-carbon elements.

The pristine graphene sheets were immersed into a 10 mM acetone solution of benzoyl peroxide (BPO) for 30 min and were then taken out drying naturally in air. The heat-initiated chemical reaction to functionalize graphene sheets was conducted at 80° C. in a high-pressure stainless steel container filled with pure nitrogen. Subsequently, the samples were rinsed thoroughly in acetone to remove BPO residues for subsequent Raman characterization. As the reaction time increased, the characteristic disorder-induced D band around 1330 cm⁻¹ emerged and gradually became the most prominent feature of the Raman spectra. The D-band is originated from the A_{1 g} mode breathing vibrations of six-membered sp² carbon rings, and becomes Raman active after neighboring sp² carbon atoms are converted to sp³ hybridization. In addition, the double resonance 2D band around 2670 cm⁻¹ became significantly weakened, while the G band around 1580 cm⁻¹ was broadened due to the presence of a defect-induced D′ shoulder peak at ˜1620 cm⁻¹. These observations suggest that covalent C—C bonds were formed and thus a degree of structural disorder was generated by the transformation from sp² to sp³ configuration due to reaction with BPO.

The functionalized graphene sheets were re-dispersed in water to produce a graphene dispersion. The dispersion was then deposited onto a layer of PP nonwoven and PVC film, respectively, to form a functionalized graphene layer coated on fabric and PVC film using comma coating. On a separate basis, non-functionalized pristine graphene sheets were also coated on PP non-woven layers to obtain pristine graphene-coated fabric structures. Graphene sheet-coated plastic films are for face shield and protective gown/cap applications.

### Example 3: Preparation of Graphene Fluoride Sheets and Graphene Layers

Several processes have been used by us to produce GF, but only one process is herein described as an example. In a typical procedure, highly exfoliated graphite (HEG) was prepared from intercalated compound C₂F.xClF₃. HEG was further fluorinated by vapors of chlorine trifluoride to yield fluorinated highly exfoliated graphite (FHEG). Pre-cooled Teflon reactor was filled with 20-30 mL of liquid pre-cooled ClF₃, the reactor was closed and cooled to liquid nitrogen temperature. Then, no more than 1 g of HEG was put in a container with holes for ClF₃ gas to access and situated inside the reactor. In 7-10 days a gray-beige product with approximate formula C₂F was formed.

Subsequently, a small amount of FHEG (approximately 0.5 mg) was mixed with 20-30 mL of an organic solvent (methanol, ethanol, 1-propanol, 2-propanol, 1-butanol, tert-butanol, isoamyl alcohol) and subjected to an ultrasound treatment (280 W) for 30 min, leading to the formation of homogeneous yellowish dispersions. Separately, a metal precursor (nickel nitrate) was dissolved in the same alcohol suspension. Five minutes of sonication was enough to obtain a relatively homogenous dispersion, but a longer sonication time ensured better stability.

Upon spraying the suspension (without the metal precursor) onto a PET fabric surface with the solvent removed, the dispersion became brownish films formed on the PET fabric surface. The dried films, upon roll-pressing, became a good filtration member. The suspension was also ultrasonic-sprayed onto a polycarbonate face shield body to make a protective shield against virus.

The suspension containing the nickel nitrate and graphene fluoride was cast over a glass surface and dried in a vacuum oven and heat-treated at 650° C. for 2 hours to produce nano-Ni-coated graphene fluoride sheets. These graphene sheets were incorporated in a face mask.

### Example 4: Preparation of Nitrogenated Graphene Sheets and Graphene Layers

Graphene oxide (GO), synthesized in Example 1, was finely ground with different proportions of urea and the pelletized mixture heated in a microwave reactor (900 W) for 30 s. The product was washed several times with deionized water and vacuum dried. In this method graphene oxide gets simultaneously reduced and doped with nitrogen. The products obtained with graphene/urea mass ratios of 1/0.5, 1/1 and 1/2 have the nitrogen contents of 14.7, 18.2 and 17.5 wt. %, respectively, as found by elemental analysis. These nitrogenated graphene sheets, without prior chemical functionalization, remain dispersible in water. The resulting suspensions were made into wet films on PET non-woven fabric layers using spray painting and then dried to form filtration members.

### Example 5: Deposition of an Activated Metal on Surfaces of Graphene Sheets

Several procedures can be used to deposit a metal coating or nano particles onto graphene sheet surfaces: electrochemical deposition or plating, pulse power deposition, electrophoretic deposition, electroless plating or deposition, metal melt coating (more convenient for lower-melting metals, such as Zn and Sn), metal precursor deposition (coating of metal precursor followed by chemical or thermal conversion of the precursor to metal), physical vapor deposition, chemical vapor deposition, and sputtering.

For instance, purified zinc sulfate (ZnSO₄) is a precursor to Zn; zinc sulfate can be coated onto a primary surface of a graphene film via solution deposition and then converted into Zn via electrolysis. In this procedure zinc sulfate solution was used as electrolyte in a tank containing a lead anode and a graphene film cathode. Current is passed between the anode and cathode and metallic zinc is plated onto the cathodes by a reduction reaction. In addition, Zn (melting point=419.5° C.) and Sn (MP=231.9° C.) in the molten state may be readily thermally sprayed onto the surfaces of graphene sheets, etc.

As an example of a higher melting point metal, precursor deposition and chemical conversion can be used to obtain metal coating. For instance, Ag coating or Ag nano particles may be formed on a graphene film by bringing an Ag nitrate, Ag acetate, Ag carbonate, Ag citrate, Ag sulfate, or Ag phosphate in direct contact with the graphene surface. For instance, by dipping a piece of graphene film in a Ag nitrate-water solution or by continuously moving a roll of graphene film (including immersing in and then emerging from a water bath of Ag acetate) can provide an opportunity for graphene films to chemically interact with Ag acetate. Upon heating at a temperature of typically 200-700° V for 1-6 hours, one could obtain a Ag-coated graphene film.

As another example, Ni nitrate, Ni acetate, Ni carbonate, Ni citrate, Ni sulfate, or Ni phosphate may be deposited onto a surface of a graphene paper sheet. The metal precursor-coated graphene paper may then be subjected to a heat treatment typically at a temperature of 250° C.-750° C. to thermally convert the Ni salt into Ni metal in the form of a coating or nano particles on the graphene surface.

We claim:

1. A graphene-based personnel protection equipment (PPE) product, comprising:
a) a fabric, clothing, face shield, or glove body configured to support graphene sheets; and
b) graphene sheets deposited on a surface of said body or at least partially embedded in said body, wherein said graphene sheets comprise a plurality of discrete single-layer or few-layer graphene sheets selected from pristine graphene, graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

2. The PPE product of claim 1, wherein said graphene sheets are chemically bonded to a surface of said body optionally using an adhesive or binder.

3. The PPE product of claim 1, wherein the fabric, clothing, face shield, or glove body comprises a woven or nonwoven structure of polymer fibers or glass fibers, or a polymer film.

4. The PPE product of claim 1, wherein the fabric, clothing, face shield, or glove body comprises a film or fibers of a polymer selected from cotton, cellulose, wool, polyolefin, polyester, polyamide, rayon, polyacrylonitrile, cellulose acetate, polystyrene, polyvinyl, poly (carboxylic acid), rubber or elastomer, a biodegradable polymer, a water-soluble polymer, a copolymer thereof, and a combination thereof.

5. The PPE product of claim 1, wherein said graphene sheets have an oxygen content from 5% to 50% by weight based on the total graphene sheet weight.

6. The PPE product of claim 1, wherein the fabric, clothing, face shield, or glove body further comprises an anti-microbial compound deposited thereon.

7. The PPE product of claim 1, wherein the product further comprises an anti-microbial compound distributed on surfaces of the graphene sheets and the graphene sheets have a specific surface area from 5 to 2,630 m²/g.

8. The PPE product of claim 7, wherein the anti-microbial compound comprises an antiviral or anti-bacteria compound selected from acrylic acid, methacrylic acid, citric acid, an acidic polymer, a silver-organic idine antibacterial agent, an iodine resin, a sialic acid, a cationic group, a sulfonamide, a fluoroquinolone, or a combination thereof.

9. A PPE product of claim 1, wherein the anti-microbial compound comprises an antiviral or anti-bacteria nano particles, nano-wires, or nano-coating of a material selected from Ti, V, Cr, Mn, Fe, Co, Ni, Cu, Zn, Zr, Mo, Pd, Ag, Cd, Au, Pt, W, Al, Sn, In, Pb, Bi, an alloy thereof, a mixture thereof, an oxide thereof, a sulfide thereof, a selenide thereof, a phosphide thereof, a boride thereof, or a combination thereof, wherein the nano particles or nanowires have a diameter or thickness from 0.5 nm to 100 nm.

10. The PPE product of claim 9, wherein said anti-microbial compound comprises silver nanowires, titanium dioxide nanoparticles, or a combination thereof.

11. A graphene-based personnel protection equipment (PPE) product, comprising:
A) a fabric, clothing, face shield, face mask, or glove body configured to support graphene sheets; and
B) graphene sheets deposited on a surface of said body or at least partially embedded in said body, wherein said graphene sheets comprise a plurality of discrete single-layer or few-layer graphene sheets selected from pristine graphene, graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof, and said graphene sheets are deposited with an anti-microbial compound selected from nano particles, nano-wires, or nano-coating of a material selected from Ti, V, Cr, Mn, Fe, Co, Ni, Cu, Zn, Zr, Mo, Pd, Ag, Cd, Au, Pt, W, Al, Sn, In, Pb, Bi, an alloy thereof, a mixture thereof, an oxide thereof, a sulfide thereof, a selenide thereof, a phosphide thereof, a boride thereof, or a combination thereof, wherein the nano particles, nano-coating, or nanowires have a diameter or thickness from 0.5 nm to 100 nm.

12. A process for producing the PPE product of claim 1, the process comprising (a) preparing a fabric, clothing, face shield, or glove body having at least one external surface; and (b) depositing graphene sheets on said at least one external surface or at least partially embedding graphene sheets into said external surface.

13. The process of claim 12, wherein step (b) comprises a procedure of dispersing discrete graphene sheets, with or without an adhesive, in a gaseous medium to form a flowing fluid and impinging the flowing fluid upon said at least one external surface, allowing said graphene sheets to adhere to said at least one external surface.

14. The process of claim 12, wherein step (b) comprises a procedure of dispersing discrete graphene sheets, with or without an adhesive, in a liquid medium to form a slurry, depositing the slurry onto said at least one external surface to form a wet graphene layer, and removing or drying the liquid medium from said wet graphene layer to form a layer of graphene sheets adhered to said external surface.

15. The process of claim 14, wherein said depositing step comprises a procedure selected from casting, coating, spraying, printing, brushing, painting, dipping, or a combination thereof.

16. The process of claim 12, further comprising a step (c), before or after step (b), of depositing an anti-microbial compound or material onto surfaces of said graphene sheets.

17. The process of claim 12, wherein step (c) comprises a procedure selected from casting, coating, spraying, printing, brushing, painting, dipping, sputtering, physical vapor deposition, chemical vapor deposition, or a combination thereof.

18. The process of claim 12, wherein the anti-microbial compound comprises an antiviral or anti-bacteria nano particles, nano-wires, or nano-coating of a material selected from Ti, V, Cr, Mn, Fe, Co, Ni, Cu, Zn, Zr, Mo, Pd, Ag, Cd, Au, Pt, W, Al, Sn, In, Pb, Bi, an alloy thereof, a mixture thereof, an oxide thereof, a sulfide thereof, a selenide thereof, a phosphide thereof, a boride thereof, or a combination thereof, wherein the nano particles, nanowires, or nano-coating have a diameter or thickness from 0.5 nm to 100 nm.

19. A process for producing a PPE product of claim 11, the process comprising (a) preparing a fabric, clothing, filter, face mask, face shield, or glove body having at least one external surface; (b) depositing graphene sheets on said at least one external surface or at least partially embedding graphene sheets into said external surface; and (c) a step, before or after step (b), of depositing an anti-microbial compound onto surfaces of said graphene sheets wherein the anti-microbial compound comprises nano particles, nano-wires, or nano-coating of a metallic material selected from Ti, V, Cr, Mn, Fe, Co, Ni, Cu, Zn, Zr, Mo, Pd, Ag, Cd, Au, Pt, W, Al, Sn, In, Pb, Bi, an alloy thereof, or a combination thereof and said metallic material is produced by bringing a metal precursor in direct contact with graphene sheets of graphene oxide, reduced graphene oxide, or functionalized graphene and converting the precursor to a metal.

20. The process of claim 19, wherein the metal precursor is selected from a metal nitrate, metal acetate, metal carbonate, metal citrate, metal sulfate, metal phosphate, or a combination thereof.

21. The process of claim 19, wherein step (c) comprising (i) mixing the metal precursor and graphene sheets in a liquid medium to form a suspension, (ii) removing the liquid medium to form dry graphene sheets coated with the metal precursor, and (iii) thermally converting the metal precursor to nano particles or nano-coating deposited on surfaces of graphene sheets.
